(19) United States
(12) Patent Application Publication
(10) Pub. No.: US 2026/0329086 A1
(43) Pub. Date: Oct. 22, 2026

(54) GRATINGS WITH REDUCED DIFFRACTION EFFICIENCIES BEYOND FABRICATION LIMITS

(71) Applicant: GOOGLE LLC, Mountain View, CA (US)

(72) Inventor: Ido Raveh, Waterloo (CA)

(21) Appl. No.: 19/105,631

(22) PCT Filed: Aug. 22, 2022
(86) PCT No.: PCT/US2022/041094

§ 371 Date: Feb. 21, 2025

(51) Int. Cl. G02B 27/01; G02B 5/18

(52) U.S. Cl. CPC G02B 27/0172; G02B 5/1809

(57) ABSTRACT

A diffraction grating includes a plurality of diffraction features and a plurality of grooves. Each groove of the plurality of grooves is adjacent to at least one diffraction feature of the plurality of diffraction features. One or more sub-wavelength features are included within either one or more of the diffraction features or one or more of the grooves. The one or more sub-wavelength features reduce a diffraction efficiency of at least one diffraction order of the diffraction grating beyond fabrication limits while still allowing the amount of light diffracted into an unwanted orthogonal direction to be controlled.

### BACKGROUND

A diffraction grating is an optical element having a periodic structure that diffracts light into several beams traveling in different directions (i.e., different diffraction angles). Stated differently, a diffraction grating separates (disperses) light into its constituent wavelengths (colors) such that each wavelength is diffracted at a slightly different angle. The directions or diffraction angles of the beams depend on the wave (light) incident angle to the diffraction grating, the spacing or distance between adjacent diffracting elements (e.g., grooves, slits, slots, etc.) on the diffraction grating, and the wavelength of the incident light. A diffraction grating is typically either a reflection grating that diffracts light back into the plane of incidence or a transmission grating that transmits dispersed light through the grating.

### SUMMARY OF EMBODIMENTS

In accordance with some embodiments, a diffraction grating includes a plurality of diffraction features and a plurality of grooves. Each groove of the plurality of grooves is adjacent to at least one diffraction feature of the plurality of diffraction features. At least one diffraction feature of the plurality of diffraction features includes one or more sub-wavelength features. The one or more sub-wavelength features reduce a diffraction efficiency of at least one diffraction order of the diffraction grating beyond fabrication limits.

In various embodiments, the diffraction grating includes one or more of the following aspects: wherein the one or more sub-wavelength features reduce a fill factor of the at least one diffraction feature; wherein each of the one or more sub-wavelength features is a depression within the at least one diffraction feature; wherein the depression forms a discontinuity in the at least one diffraction feature; wherein the at least one diffraction feature comprises a plurality of portions separated by the one or more sub-wavelength features; wherein a pitch of the one or more sub-wavelength features is equal to a pitch of the plurality of diffraction features; or wherein the plurality of diffraction features, the one or more sub-wavelength features, and the plurality of grooves are configured such that light is only diffracted in an x-axis of the diffraction grating.

In accordance with some embodiments, a diffraction grating includes a plurality of diffraction features and a plurality of grooves. Each groove of the plurality of grooves is adjacent to at least one diffraction feature of the plurality of diffraction features. At least one groove of the plurality of grooves comprises one or more sub-wavelength features. The one or more sub-wavelength features reduce a diffraction efficiency of at least one diffraction order of the diffraction grating beyond fabrication limits.

In various embodiments, the diffraction grating includes one or more of the following aspects: wherein the one or more sub-wavelength features increase a fill factor of the plurality of diffraction features; wherein each of the one or more sub-wavelength features is an island of diffraction material within the at least one groove; wherein the island of diffraction material comprises the same material as the plurality of diffraction features; wherein a pitch of the one or more sub-wavelength features is equal to a pitch of the plurality of diffraction features; or wherein the plurality of diffraction features, the plurality of grooves, and the one or more sub-wavelength features are configured such that light is only diffracted in an x-axis of the diffraction grating.

In accordance with some embodiments, a waveguide includes a volume of optically transparent material, an incoupler grating carried by the volume of optically transparent material, and an outcoupler grating carried by the volume of optically transparent material. The outcoupler grating includes a plurality of diffraction features and a plurality of grooves. Each groove of the plurality of grooves being adjacent to at least one diffraction feature of the plurality of diffraction features. The outcoupler grating further includes one or more sub-wavelength features configured in one at least one diffraction feature of the plurality of diffraction features or at least one groove of the plurality of grooves. The one or more sub-wavelength features reduce a diffraction efficiency of at least one diffraction order of the outcoupler grating beyond fabrication limits.

In various embodiments, the waveguide further includes one or more of the following aspects: wherein the one or more sub-wavelength features one of reduce or increase a fill factor of the plurality of diffraction features; wherein each of the one or more sub-wavelength features is either a depression within the at least one diffraction feature or is an island of diffraction material within the at least one groove; wherein the depression forms a discontinuity in the at least one diffraction feature; wherein the island of diffraction material comprises the same material as the plurality of diffraction features; wherein the at least one diffraction feature comprises a plurality of portions separated by the one or more sub-wavelength features; or wherein the plurality of diffraction features, the one or more sub-wavelength features, and the plurality of grooves are configured such that light is only diffracted in an x-axis of the outcoupler.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is an isometric view of a one-dimensional (1D) diffraction grating in accordance with some embodiments.

FIG. 2 is an isometric view of a diffraction grating comprising sub-wavelength features for reducing the diffraction efficiency of wanted orders beyond fabrication limitations in accordance with some embodiments.

FIG. 3 is a cross-sectional view of the diffraction grating of FIG. 2 taken along the y-axis of the grating in accordance with some embodiments.

FIG. 4 is a top view of the diffraction grating of FIG. 2 in accordance with some embodiments.

FIG. 5 is an isometric view of another diffraction grating comprising sub-wavelength features for reducing the diffraction efficiency of wanted orders beyond fabrication limitations in accordance with some embodiments.

FIG. 6 is a top view of the diffraction grating of FIG. 5 in accordance with some embodiments.

FIG. 7 is a diagram illustrating a laser projection having a waveguide implementing the diffraction grating of either FIG. 2 or FIG. 5 as an outcoupler, in accordance with some embodiments.

### DETAILED DESCRIPTION

Optical diffraction gratings are used in various applications, including waveguides (lightguides). For example, in at least some waveguides, a diffraction grating is used as an incoupler and an outcoupler. An incoupler grating couples at least a portion of incident light from a light engine into the waveguide, thereby forming guided light. An outcoupler grating couples a portion of the guided light out of the waveguide towards, for example, a user's eye. Diffraction gratings are also used to control the propagation of the light within the waveguide. One type of diffraction grating is a one-dimensional (1D) grating that diffracts light in the x-axis only. In other words, a 1D grating controls the light in one direction and does not affect light in the orthogonal direction.

One attribute of diffraction gratings is the diffraction efficiency (DE), which is the measure of how much optical power is diffracted into a designated direction compared to the optical power incident onto the diffractive element of the grating. A 1D diffraction grating having a high diffraction efficiency indicates that the majority of the optical power will be in the desired diffraction order (e.g., +1 or −1 order) while minimizing the power lost to other orders (e.g., 0^{th} order). A 1D diffraction grating having a low diffraction efficiency indicates that the majority of the optical power will be lost in the desired diffraction order (e.g., +1 or −1 order). In waveguide (and other) environments that implement 1D gratings, a 1D incoupler grating having a high diffraction efficiency is typically desirable so that as much of the incoming light is coupled into the waveguide. However, for the outcoupler grating or exit pupil expander (EPE), a low diffraction efficiency 1D grating is typically desired so that the majority of the light goes to the transmission/reflection 0^{th} orders. For example, if the 1D outcoupler grating has a high diffraction efficiency for the +1/−1 diffraction orders, the light output from the 1D outcoupler grating tends to have a very high gradient of intensity (i.e., non-uniform intensity), which is undesirable. If the 1D outcoupler grating has a low diffraction efficiency for the +1/−1 diffraction orders, the majority of the light goes to the reflection 0^{th} orders, thereby resulting in a more uniform intensity across the eyebox. As such, a low diffraction efficiency grating is typically desired for an outcoupler grating, exit pupil expander grating, and the like.

One technique for lowering the diffraction efficiency of a grating includes reducing the grating height and the grating pitch. However, for a given grating height, the diffraction efficiency is typically governed by the fill factor of the grating, which is the fraction of the grating period that is filled with grating material. The upper bound and the lower bound of the fill factor are limited by the minimum critical dimension (CD) of the fabrication process used to fabricate the grating, which refers to the smallest feature size obtainable by the fabrication process. Therefore, although the diffraction efficiency of a grating can be lowered by increasing/decreasing the grating duty cycle (fill factor), once these dimensions reach the minimum CD of the fabrication process, the fill factor is upper/lower bound limited. This upper/lower bound limitation prevents the associated diffraction efficiency from being further reduced resulting in various issues, such as non-uniform light intensity being output from a waveguide.

Accordingly, described herein are example diffraction gratings having a reduced diffraction efficiency beyond fabrication limits. In at least some embodiments, sub-wavelength features are introduced onto a diffraction grating during fabrication. One example of a sub-wavelength feature includes depressions/voids (low-reliefs) in a grating ridge (elevation or high-relief). Another example of a sub-wavelength feature includes protrusions (e.g., added grating material) in the grooves adjacent to ridges of the grating. The sub-wavelength features change the effective fill factor and reduce the diffraction efficiency of the grating beyond fabrication limits while allowing the amount of light diffracted into an unwanted orthogonal direction to be controlled. As such, although the physical configuration of the diffraction grating more closely resembles a 2D diffraction grating, the behavior of the diffraction grating more closely resembles a 1D grating, i.e., majority of light is directed in the x-axis direction and not the y-axis direction.

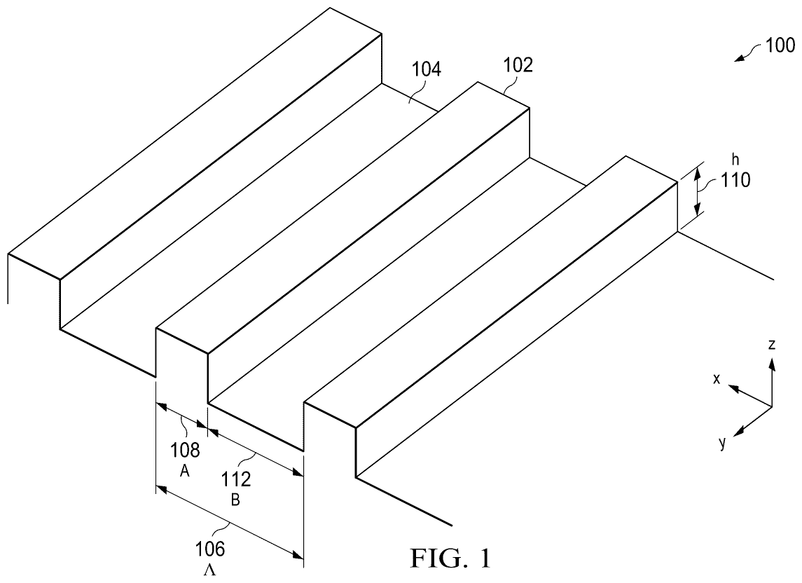

FIG. 1 is an isometric view of a portion of an example 1D diffraction grating 100 (herein referred to as “grating 100” for brevity). In this example, the grating 100 is a binary grating and does not comprise the DE reducing sub-wavelength features of at least some embodiments. It should be understood that although a binary 1D diffraction grating is used to illustrate one or more embodiments, the following description is applicable to any type of 1D diffraction grating profile, such as a binary profile, non-binary profile, a blazed profile, a slanted profile, and the like. The grating 100 comprises a set of diffraction features 102 (also referred to herein as “ridges 102” or “elevations” 102). In the example shown in FIG. 1, the set of diffraction features 102 is continuous along the y-axis. The set of diffraction features 102 are separated by a set of grooves 104 (also referred to herein as “spaces 104” or “depressions 104”), which have a low relief compared to the high relief of the set of diffraction features 102.

Each diffraction feature 102 comprises a grating pitch (period) ∧106, a grating line width A 108, a grating height h 110, and a grating space width B 112. The fill factor (duty cycle) of the grating 100 is defined as the ratio between the grating line width A 108 and the pitch ∧106, i.e., A/∧. The set of diffraction features 102 comprises a material having a first refractive index and the air (or other material) between each diffraction feature 102. has a second refractive index. The grating line pitch ∧106 comprises the distance between one edge of a given diffraction feature 102 and the same edge of the immediately adjacent diffraction feature 102. In at least some embodiments, the grating period ∧106 is constant throughout the grating 100 or varies across the grating 100. The grating line width A 108 comprises the fraction of the surface of the grating 100 made up of diffraction features 102. When the grating line width A 108 is wide, there are very narrow grooves 104 between each diffraction feature 102, and when the grating line width A 108 is narrow, there are wide grooves between each diffraction feature 102. The grating height h 110 comprises the height of the diffraction features 102.

The diffraction efficiency of each order (e.g., +1 order, 0 order, −1 order, etc.) of the grating 100 is determined by the grating height h 110 and the grating fill factor (A/∧). Stated differently, the diffraction efficiency of each order varies as the grating line width A 108, and grating height h 110 vary. In a 1D diffraction grating, the maximum diffraction efficiency for an order typically occurs at fill factor=0.5 and the minimum diffraction efficiency for an order occurs at fill factor values that are closer to 0 or 1. In many applications, such as an outcoupler of a waveguide/lightguide, it is desirable to have a 1D grating with very low diffraction efficiency for the +1/−1 diffraction orders. However, as described above, the features of the grating 100 cannot be smaller than the minimum CD of the fabrication process, i.e., Min CD≤A, B<∧ or 2*Min CD≤∧. As such, the lower/upper bounds of the grating fill factor are limited by the minimum CD constraint, i.e., Min CD/∧≤Fill Factor≤(1−Min CD/∧).

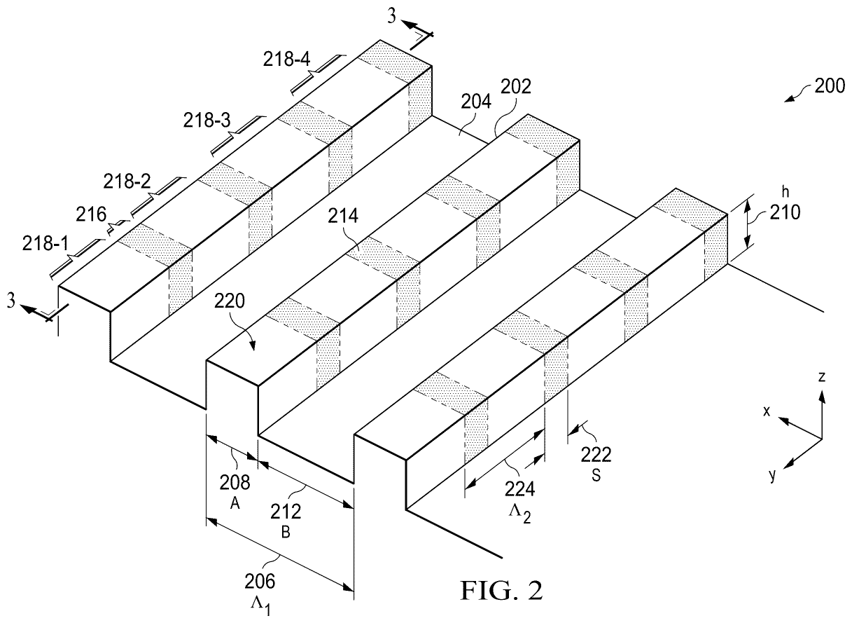

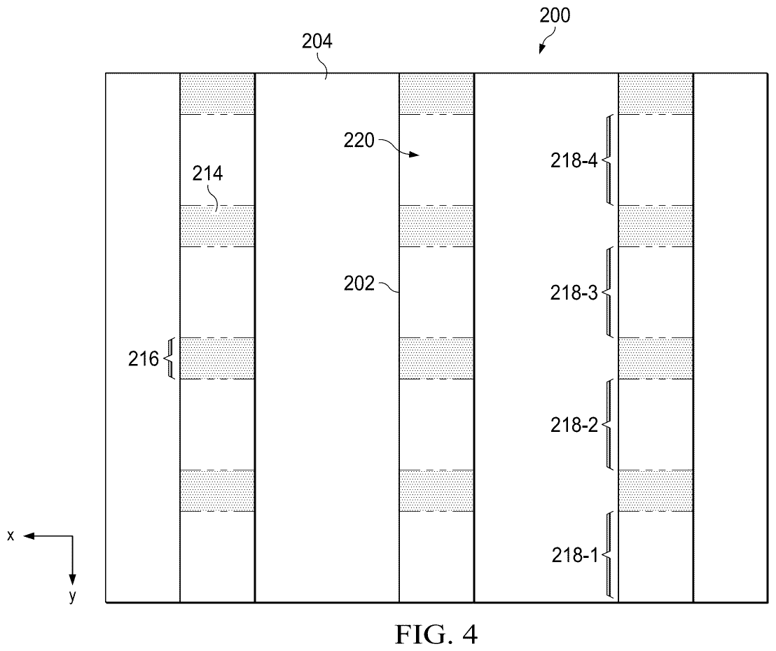

FIG. 2 to FIG. 4 illustrate different views of a portion of another example diffraction grating 200 (herein referred to as “grating 200” for brevity) that overcomes the minimum CD constraints on the fill factor lower/upper bounds of a 1D diffraction grating. As such, the configuration of the grating 200 results in the +1/−1 diffraction orders having a lower diffraction efficiency beyond fabrication limits. It should be understood that the configuration of the diffraction grating 200 is applicable to both transmission gratings and reflective gratings. The grating 200 comprises a set of diffraction features 202 (also referred to herein as “ridges 202” or “elevations” 202). The set of ridges 202 are separated by a set of grooves 204 (also referred to herein as “spaces 204” or “depressions 204”), which have a low relief compared to the high relief of the set of diffraction features 204. Each diffraction feature 202 comprises a grating pitch (period) ∧₁ 206, a grating line width A 208, a grating height h 210, and a grating space width B 212. The fill factor of the grating 200 is defined as the ratio between the grating line width A 208 and the pitch ∧₁ 206, i.e., A/∧₁. The set of diffraction features 202 comprises material of a first refractive index, and the grooves 204 between each diffraction feature 202 comprises a second material with a second refractive index or air. In at least some embodiments, the second material is air. The grating period ∧₁ 206 is constant throughout the grating 200.

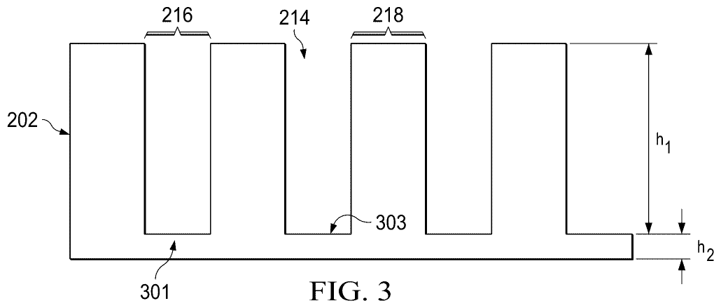

In at least some embodiments, at least one of the diffraction features 202 includes one or more sub-wavelength features 214. These features 214 are referred to as sub-wavelength features because their physical dimensions are less than the wavelength of incident light. In the example illustrated in FIG. 2 to FIG. 4, the sub-wavelength features 214 are depressions within the diffraction features 202. Stated differently, the sub-wavelength features 214 are regions/areas 216 (patterned areas with dashed-lines in FIG. 2) of the diffraction features 202 where the first diffraction material has been removed or not formed during fabrication. As such, a diffraction feature 202 comprising the sub-wavelength features 214 is discontinuous along, for example, the y-axis (long axis) of the grating 200 in FIG. 2. In other words, the sub-wavelength features 214 form discontinuities in the diffraction feature 202 such that the diffraction feature 202 comprises a plurality of portions 218 (illustrated as portion 218-1 to portion 218-4) separated by and adjacent to a sub-wavelength feature 214. The sub-wavelength features 214, in at least some embodiments, are distributed perpendicular to the grating k-vector of the diffraction feature 202. In at least some embodiments, a sub-wavelength feature 214 extends from the top surface 220 of the diffraction feature 202 to the top surface of an underlying substrate (not shown). In other embodiments, a portion 301 (FIG. 3) of the diffraction feature 202 remains in the region 216 comprising the sub-wavelength feature 214 such that the top surface 303 of this portion 301 comprises a height h₂ that is less than a height h₁ of an adjacent portion(s) 218 of the diffraction feature 202 without the sub-wavelength feature 214.

Each sub-wavelength feature 214 comprises a size S 222. In at least some embodiments, the size of the sub-wavelength features 214 is constant across the grating 200. In other embodiments, the size of the sub-wavelength features 214 varies between two or more sub-wavelength features 214. Also, the size S 222 of the sub-wavelength features 214 and the orthogonal pitch ∧₂ 224 of the sub-wavelength features 214 satisfy the minimum CD of the fabrication process, i.e., Min CD≤S and Min CD≤(∧₂−S). However, because the sub-wavelength features 214 remove portions of the diffraction features 202, the fill factor (A/∧₁) of the grating 200 is reduced beyond what is obtainable with the grating configuration of FIG. 1 given the minimum CD of the fabrication process. As such, the grating 200 comprises a diffraction efficiency for at least the +1 and −1 orders that is lower than what is achievable without the sub-wavelength features 214 given fabrication limitations. Also, in at least some embodiments, the size S 222 and orthogonal pitch ∧₂ 224 of the sub-wavelength features 214 are such that the energy directed into the orthogonal direction is either evanescent or very small, i.e., (2*Min CD)≤∧₂≤∧₁ for minimizing the propagation of light into an unwanted direction. As such, although the configuration of the grating 200 illustrated in FIG. 2 to FIG. 4 resembles a 2D grating, the size S 222 and orthogonal pitch ∧₂ 224 of the sub-wavelength features 214 is configured such that the grating 200 behaves similar to a 1D diffraction grating, i.e., majority of light is directed in the x-axis direction and not an orthogonal direction.

In at least some embodiments, the orthogonal pitch ∧₂ 224 of the sub-wavelength features 214 is set equal to (or approximately equal to) the pitch ∧₁ 206 of the diffraction features 202 such that a small amount of light leakage is allowed towards the orthogonal direction, wherein “small” refers to less than or equivalent to the amount of energy that goes to the desired direction. In these embodiments, a waveguide implementing the diffraction grating 200 also implements one or more other diffraction gratings that couple the leaked light towards an undesired direction (e.g., an orthogonal direction). By allowing a small amount of light to leak into the orthogonal direction, the diffraction efficiency towards wanted orders (e.g., +1 or −1) is further reduced.

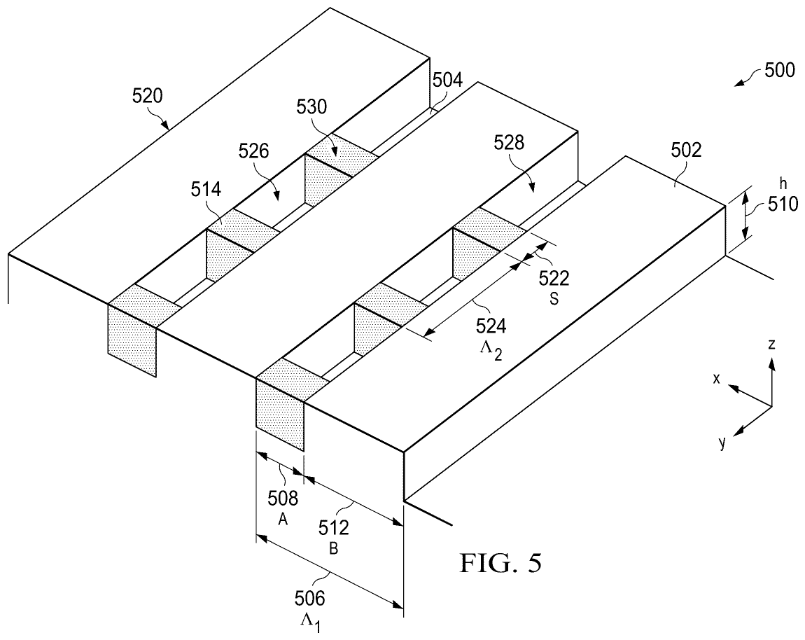

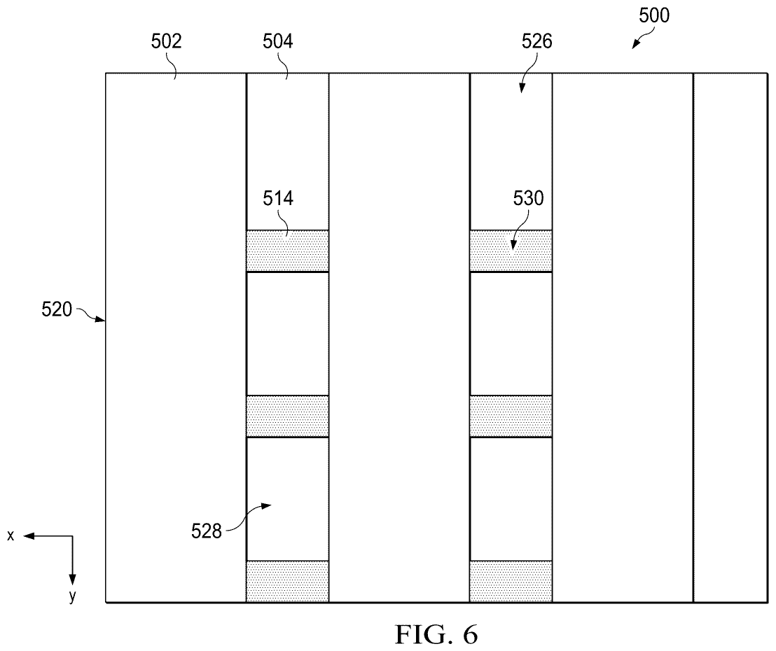

FIG. 5 and FIG. 6 illustrate different views of a portion of a further example diffraction grating 500 (herein referred to as “grating 500” for brevity) that overcomes the minimum CD constraints on the fill factor lower/upper bounds of a 1D diffraction grating. As such, similar to the grating 200 of FIG. 2, the configuration of the grating 500 results in the +1/−1 diffraction orders having a lower diffraction efficiency beyond fabrication limits. It should be understood that the configuration of the diffraction grating 500 is applicable to both transmission gratings and reflective gratings. The grating 500 comprises a set of diffraction features 502 (also referred to herein as “ridges 502” or “elevations” 502). The set of ridges 502 are separated by a set of grooves 504 (also referred to herein as “spaces 504” or “depressions 504”), which have a low relief compared to the high relief of the set of diffraction features 504. Each diffraction feature 502 comprises a grating pitch (period) ∧₁ 506, a grating line width A 508, a grating height h 510, and a grating space width B 512. The fill factor (duty cycle) of the grating 500 is defined as the ratio between the grating line width A 208 and the pitch ∧₁ 206, i.e., A/∧₁. The set of diffraction features 502 comprises material of a first refractive index, and the grooves 504 between each diffraction feature 502 comprises a second material with a second refractive index. In at least some embodiments, the second material is air. The grating period ∧₁ 506 is constant throughout the grating 500.

In at least some embodiments, at least one of the grooves 504 includes one or more sub-wavelength features 514. These features 514 are referred to as sub-wavelength features because their physical dimensions are less than the wavelength of incident light. In the example illustrated in FIG. 5 and FIG. 6, the sub-wavelength features 514 are protrusions/islands of diffraction material within the groove 504. Stated differently, the sub-wavelength features 514 are protrusions/islands of diffraction material that have been added to one or more of the grooves 504 during fabrication. In at least some embodiments, the diffraction material of the sub-wavelength features 514 is the same as the diffraction material of the diffraction features 502. In other embodiments, the diffraction material of the sub-wavelength features 514 is different from the diffraction material of the diffraction features 502. In at least some embodiments, a sub-wavelength feature 514 extends from the top region 526 of the groove 504 to the bottom surface 528 of the groove 504 (or the top surface of an underlying substrate (not shown)). The top surface 530 of a sub-wavelength feature 514, in at least some embodiments, is co-planar with the top surface 520 of an adjacent diffraction feature 502. In other embodiments, the top surface 530 of the sub-wavelength feature 514 is not co-planar with the top surface 520 of an adjacent diffraction feature 502.

Each sub-wavelength feature 514 comprises a size S 522. In at least some embodiments, the size of the sub-wavelength features 514 is constant across the grating 500. In other embodiments, the size of the sub-wavelength features 514 varies between two or more sub-wavelength features 514. Also, the size S 522 of the sub-wavelength features 514 and the orthogonal pitch ∧₂ 524 of the sub-wavelength features 514 satisfy the minimum CD of the fabrication process, i.e., Min CD≤S and Min CD≤(∧₂−S). However, because the sub-wavelength features 514 add additional diffraction material corresponding to the diffraction features 502, the fill factor (A/∧₁) of the grating 500 is increased beyond what is obtainable with the grating configuration of FIG. 1 given the minimum CD of the fabrication process. As such, the grating 500 comprises a diffraction efficiency for at least the +1 and −1 orders that is lower than what is achievable without the sub-wavelength features 514 given fabrication limitations. Also, in at least some embodiments, the size S 522 and orthogonal pitch ∧₂ 524 of the sub-wavelength features 214 are such that the energy directed into the orthogonal direction is either evanescent or very small, i.e., (2*Min CD)≤∧₂≤∧₁ for minimizing the propagation of light into an unwanted direction. As such, although the configuration of the grating 500 illustrated in FIG. 5 resembles a 2D grating, the size S 522 and orthogonal pitch ∧₂ 524 of the sub-wavelength features 514 is configured such that the grating 500 behaves similar to a 1D diffraction grating, i.e., majority of light is directed in the x-axis direction and not an orthogonal direction. Also, similar to the grating 200 of FIG. 2, the orthogonal pitch ∧₂ 524 of the sub-wavelength features 514 can be set equal to (or approximately equal to) the pitch ∧₁ 506 of the diffraction features 402 such to allow a small amount of light to leak into the orthogonal direction, thereby further reducing the diffraction efficiency towards wanted orders (e.g., +1 or −1).

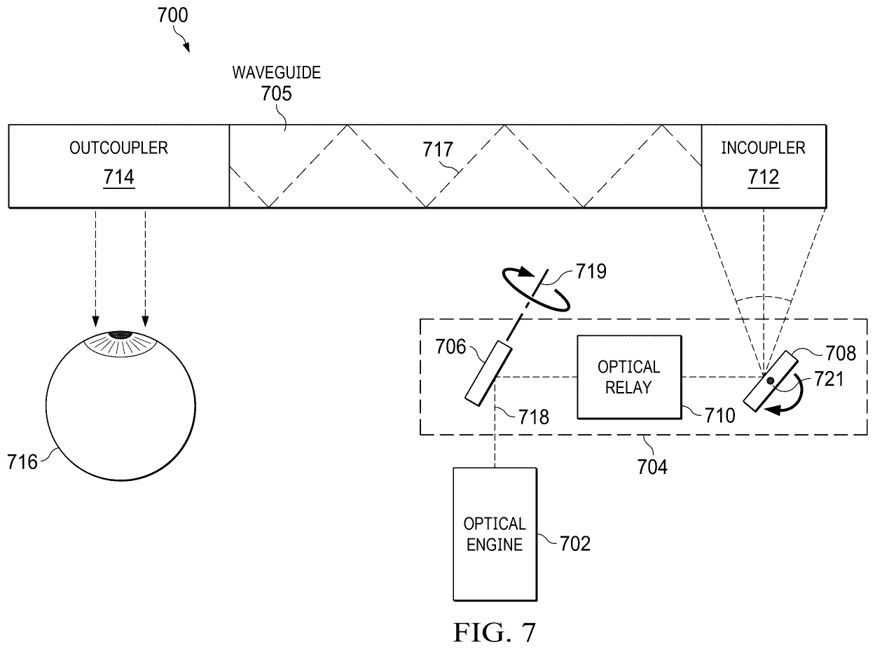

As described above, the gratings 200, 500 illustrated in FIG. 2 to FIG. 6 can be implemented in various applications, including waveguide outcouplers, exit pupil expanders, and the like. FIG. 7 illustrates one example of waveguide 705 in one example of a laser projection system 700 capable of implementing one or more of the diffraction gratings 200, 500 described herein. The laser projection system 700 of FIG. 7 is configured to project images directly onto the eye of a user via laser light. The laser projection system 700 includes an optical engine 702, an optical scanner 704, and a waveguide 705. The optical scanner 704 includes a first scan mirror 706, a second scan mirror 708, and an optical relay 710. The waveguide 705 includes an incoupler grating 712 (herein referred to as “incoupler 712) and an outcoupler grating 714 (herein referred to as ”outcoupler 714), with the outcoupler 714 being optically aligned with an eye 716 of a user in the present example. In at least some embodiments, the waveguide 705 also includes a volume of optically transparent material 717 that carries the incoupler 712 and the outcoupler 714. The outcoupler 714, in this example, is comprised of either the diffraction grating 200 of FIG. 2 to FIG. 4 or the diffraction grating 500 of FIG. 5 and FIG. 6. In at least some embodiments, the laser projection system 700 is implemented in a wearable heads-up display or another display system.

The optical engine 702 includes one or more laser light sources configured to generate and output laser light 718 (e.g., visible laser light such as red, blue, and green laser light and, in at least some embodiments, non-visible laser light such as infrared laser light). In at least some embodiments, the optical engine 702 is coupled to a driver or other controller (not shown), which controls the timing of emission of laser light from the laser light sources of the optical engine 702 in accordance with instructions received by the controller or driver from a computer processor coupled thereto to modulate the laser light 718 to be perceived as images when output to the retina of an eye 716 of a user.

For example, during operation of the laser projection system 700, multiple laser light beams having respectively different wavelengths are output by the laser light sources of the optical engine 702, then combined via a beam combiner (not shown), before being directed to the eye 716 of the user. The optical engine 702 modulates the respective intensities of the laser light beams so that the combined laser light reflects a series of pixels of an image, with the particular intensity of each laser light beam at any given point in time contributing to the amount of corresponding color content and brightness in the pixel being represented by the combined laser light at that time.

One or both of the first and second scan mirrors 706 and 708 of the optical scanner 704 are MEMS mirrors in some embodiments. For example, the first scan mirror 706 and the second scan mirror 708 are MEMS mirrors that are driven by respective actuation voltages to oscillate during active operation of the laser projection system 700, causing the first and second scan mirrors 706 and 708 to scan the laser light 718. Oscillation of the first scan mirror 706 causes laser light 718 output by the optical engine 702 to be scanned through the optical relay 710 and across a surface of the second scan mirror 708. The second scan mirror 708 scans the laser light 718 received from the first scan mirror 706 toward an incoupler 712 of the waveguide 705. In some embodiments, the first scan mirror 706 oscillates or otherwise rotates around a first axis 719, such that the laser light 718 is scanned in only one dimension (i.e., in a line) across the surface of the second scan mirror 708. In some embodiments, the second scan mirror 708 oscillates or otherwise rotates around a second axis 721. In some embodiments, the first axis 719 is skew with respect to the second axis 721.

In some embodiments, the incoupler 712 has a substantially rectangular profile and is configured to receive the laser light 278 and direct the laser light 718 into the waveguide 705. The incoupler 712 is defined by a smaller dimension (i.e., width) and a larger orthogonal dimension (i.e., length). In an embodiment, the optical relay 710 is a line-scan optical relay that receives the laser light 718 scanned in a first dimension by the first scan mirror 706 (e.g., the first dimension corresponding to the small dimension of the incoupler 712), routes the laser light 718 to the second scan mirror 708, and introduces a convergence to the laser light 718 (e.g., via collimation) in the first dimension to an exit pupil plane of the optical relay 710 beyond the second scan mirror 708. Herein, a “pupil plane” refers to a location along the optical path of laser light through an optical system where the laser light converges to an aperture along one or more dimensions. For example, the optical relay 710, in at least some embodiments, is associated with one or more entrance pupil planes located along the optical path of laser light through the optical system where the laser light converges to a virtual aperture before entering the optical relay 710. For example, the optical relay 710 can be associated with one or more exit pupil planes located along the optical path of laser light through the optical system where the laser light converges to a virtual aperture along one or more dimensions after exiting the optical relay 710. In at least some embodiments, an entrance pupil plane of the optical relay 710 is located coincident with the first scan mirror 706. In other embodiments, an entrance pupil plane of the optical relay 710 is located at an intermediate location between the first scan mirror 706 and the optical relay 710. In at least some embodiments, an exit pupil plane of the optical relay 710 is located coincident with the second scan mirror 708. In other embodiments, an exit pupil plane of the optical relay 710 is located coincident with the incoupler 712.

In some instances, the laser light converges to a virtual aperture of a first entrance pupil plane along a first dimension (e.g., with the laser light converging along the x-y dimension to a point or line along a z dimension with respect to a cartesian coordinate system having x-, y-, and z-axes) and converges to a virtual aperture of a second entrance pupil plane along a second dimension (e.g., the second dimension being substantially perpendicular to the first dimension), where the first and second entrance pupil planes differ with respect to location. In some instances, the laser light converges to a virtual aperture of a first exit pupil plane along a first dimension (e.g., with the laser light converging along the x-y dimension to a point or line along a z dimension with respect to a cartesian coordinate system having x-, y-, and z-axes) and converges to a virtual aperture of an exit entrance pupil plane along a second dimension (e.g., the second dimension being substantially perpendicular to the first dimension), where the first and second exit pupil planes differ with respect to location. In other instances, the laser light converges to a virtual aperture of a single entrance pupil plane along all dimensions (e.g., with the laser light converging to the virtual aperture along each of the x, y, and z dimensions) and converges to a virtual aperture of a single exit pupil plane along all dimensions.

While, in the present example, the optical engine 702 is shown to output a single beam of laser light 718 (which itself may be a combination of two or more beams of light having respectively different polarizations or wavelengths) toward the first scan mirror, in some embodiments, the optical engine 702 is configured to generate and output two or more laser light beams toward the first scan mirror, where the two or more laser light beams are angularly separated with respect to one another (i.e., they are “angularly separated laser light beams”). As described previously, two or more laser light beams are “angularly separated” when they propagate along respectively different non-parallel and non-perpendicular optical paths that are tilted (e.g., angularly offset) with respect to one another, with the angular separation of the optical paths, in some instances, causing the two or more laser light beams to converge to overlap one another along one or more dimensions (e.g., such overlap corresponding to a virtual aperture of a pupil plane).

In the present example, the possible optical paths of the laser light 718, following reflection by the first scan mirror 706, are initially spread along a first scanning dimension, but later these paths intersect at an exit pupil plane beyond the second scan mirror 708 due to convergence introduced by the optical relay 710. For example, the width (i.e., smallest dimension) of a given exit pupil plane approximately corresponds to the diameter of the laser light corresponding to that exit pupil plane. Accordingly, the exit pupil plane can be considered a “virtual aperture”. In some embodiments, the exit pupil plane of the optical relay 710 is coincident with the incoupler 712. In some embodiments, an entrance pupil plane of the optical relay 710 is coincident with the first scan mirror 706.

According to various embodiments, the optical relay 710 includes one or more spherical, aspheric, parabolic, or freeform lenses that shape and relay the laser light 718 on the second scan mirror 708 or includes a molded reflective relay that includes two or more optical surfaces that include, but are not limited to, spherical, aspheric, parabolic, or freeform lenses or reflectors (sometimes referred to as “reflective surfaces” herein), which shape and direct the laser light 718 onto the second scan mirror 708. The second scan mirror 708 receives the laser light 718 and scans the laser light 718 in a second dimension, the second dimension corresponding to the long dimension of the incoupler 712 of the waveguide 705. In at least some embodiments, the second scan mirror 708 causes the exit pupil plane of the laser light 718 to be swept along a line along the second dimension. In some embodiments, the incoupler 712 is positioned at or near the swept line downstream from the second scan mirror 708 such that the second scan mirror 708 scans the laser light 718 as a line or row over the incoupler 712.

In at least some embodiments, the optical engine 702 includes an edge-emitting laser (EEL) that emits a laser light 718 having a substantially elliptical, non-circular cross-section, and the optical relay 710 magnifies or minimizes the laser light 718 along one or both of a first direction (e.g., the semi-major axis of the beam profile of the laser light 718) or a second direction (e.g., the semi-minor axis of the beam profile of the laser light 718) to reshape (e.g., circularize) the laser light 718 prior to the convergence of the laser light 718 on the second scan mirror 708. In some such embodiments, a surface of a mirror plate of the first scan mirror 706 is elliptical and non-circular (e.g., similar in shape and size to the cross-sectional area of the laser light 718). In other such embodiments, the surface of the mirror plate of the first scan mirror 706 is circular.

The waveguide 705 of the laser projection system 700 includes, for example, the incoupler 712 and the outcoupler 714. The term “waveguide,” as used herein, will be understood to mean a combiner using one or more of total internal reflection (TIR), specialized filters, or reflective surfaces, to transfer light from an incoupler (such as the incoupler 712) to an outcoupler (such as the outcoupler 714). In some display applications, the light is a collimated image, and the waveguide transfers and replicates the collimated image to the eye. In at least some embodiments, a given incoupler or outcoupler is configured as a transmissive grating that causes the incoupler or outcoupler to transmit light and to apply designed optical function(s) to the light during the transmission. In at least some embodiments, a given incoupler or outcoupler is a reflective grating that causes the incoupler or outcoupler to reflect light and to apply designed optical function(s) to the light during the reflection. In the present example, the laser light 718 received at the incoupler 712 is relayed to the outcoupler 714 via the waveguide 705 using TIR. The laser light 718 is then output to the eye 716 of a user via the outcoupler 714. As described above, in at least some embodiments, the waveguide 705 is implemented as part of an eyeglasses lens of a display system having an eyeglass form factor and employing the laser projection system 700.

Although not shown in the example of FIG. 7, in at least some embodiments, additional optical components are included in any of the optical paths between the optical engine 702 and the first scan mirror 706, between the first scan mirror 706 and the optical relay 710, between the optical relay 710 and the second scan mirror 708, between the second scan mirror 708 and the incoupler 712, between the incoupler 712 and the outcoupler 714, or between the outcoupler 714 and the eye 716 (e.g., in order to shape the laser light for viewing by the eye 716 of the user). In at least some embodiments, a prism is used to steer light from the second scan mirror 708 into the incoupler 712 so that light is coupled into incoupler 712 at the appropriate angle to encourage propagation of the light in waveguide 705 by TIR. Also, in some embodiments, an exit pupil expander is arranged in an intermediate stage between incoupler 712 and outcoupler 714 to receive light that is coupled into waveguide 705 by the incoupler 712, expand the light, and redirect the light towards the outcoupler 714, where the outcoupler 714 then couples the laser light out of waveguide 705 (e.g., toward the eye 716 of the user).

In some embodiments, certain aspects of the techniques described above may be implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or features described above in the general description are required, that a portion of a specific activity or device may not be required, and that one or more further activities may be performed, or features included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

1. A diffraction grating comprising:
a plurality of diffraction features, wherein at least one diffraction feature of the plurality of diffraction features comprises one or more sub-wavelength features; and
a plurality of grooves, wherein each groove of the plurality of grooves is adjacent to at least one diffraction feature of the plurality of diffraction features,
wherein the one or more sub-wavelength features reduce a diffraction efficiency of at least one diffraction order of the diffraction grating beyond fabrication limits.

2. The diffraction grating of claim 1, wherein the one or more sub-wavelength features reduce a fill factor of the at least one diffraction feature.

3. The diffraction grating of claim 1, wherein each of the one or more sub-wavelength features is a depression within the at least one diffraction feature.

4. The diffraction grating of claim 3, wherein the depression forms a discontinuity in the at least one diffraction feature.

5. The diffraction grating of claim 1, wherein the at least one diffraction feature comprises a plurality of portions separated by the one or more sub-wavelength features.

6. The diffraction grating of claim 1, wherein a pitch of the one or more sub-wavelength features is equal to a pitch of the plurality of diffraction features.

7. The diffraction grating of claim 1, wherein the plurality of diffraction features, the one or more sub-wavelength features, and the plurality of grooves are configured such that light is only diffracted in an x-axis of the diffraction grating.

8. A diffraction grating comprising:
a plurality of diffraction features; and
a plurality of grooves, each groove of the plurality of grooves is adjacent to at least one diffraction feature of the plurality of diffraction features, wherein at least one groove of the plurality of grooves comprises one or more sub-wavelength features, and
wherein the one or more sub-wavelength features reduce a diffraction efficiency of at least one diffraction order of the diffraction grating beyond fabrication limits.

9. The diffraction grating of claim 8, wherein the one or more sub-wavelength features increase a fill factor of the plurality of diffraction features.

10. The diffraction grating of claim 8, wherein each of the one or more sub-wavelength features is an island of diffraction material within the at least one groove.

11. The diffraction grating of claim 10, wherein the island of diffraction material comprises the same material as the plurality of diffraction features.

12. The diffraction grating of claim 8, wherein a pitch of the one or more sub-wavelength features is equal to a pitch of the plurality of diffraction features.

13. The diffraction grating of claim 8, wherein the plurality of diffraction features, the plurality of grooves, and the one or more sub-wavelength features are configured such that light is only diffracted in an x-axis of the diffraction grating.

14. A waveguide comprising:
a volume of optically transparent material;
an incoupler grating carried by the volume of optically transparent material; and
an outcoupler grating carried by the volume of optically transparent material, wherein the outcoupler grating comprises:
a plurality of diffraction features; and
a plurality of grooves, each groove of the plurality of grooves being adjacent to at least one diffraction feature of the plurality of diffraction features; and
one or more sub-wavelength features configured in one at least one diffraction feature of the plurality of diffraction features or at least one groove of the plurality of grooves, wherein the one or more sub-wavelength features reduce a diffraction efficiency of at least one diffraction order of the outcoupler grating beyond fabrication limits.

15. The waveguide of claim 14, wherein the one or more sub-wavelength features one of reduce or increase a fill factor of the plurality of diffraction features.

16. The waveguide of claim 14, wherein each of the one or more sub-wavelength features is either a depression within the at least one diffraction feature or is an island of diffraction material within the at least one groove.

17. The waveguide of claim 16, wherein the depression forms a discontinuity in the at least one diffraction feature.

18. The waveguide of claim 16, wherein the island of diffraction material comprises the same material as the plurality of diffraction features.

19. The waveguide of claim 14, wherein the at least one diffraction feature comprises a plurality of portions separated by the one or more sub-wavelength features.

20. The waveguide of claim 14, wherein the plurality of diffraction features, the one or more sub-wavelength features, and the plurality of grooves are configured such that light is only diffracted in an x-axis of the outcoupler grating.
